(19) United States
(12) Patent Application Publication
(10) Pub. No.: US 2013/0011081 A1
(43) Pub. Date: Jan. 10, 2013

(54) IMAGE PROCESSING APPARATUS, IMAGE PROCESSING METHOD, PROGRAM AND RECORDING MEDIUM

(76) Inventors: Jun LUO, Tokyo (JP); Takefumi Nagumo, Kanagawa (JP)

(21) Appl. No.: 13/536,900

(22) Filed: Jun. 28, 2012

(30) Foreign Application Priority Data
Jul. 7, 2011 (JP) 2011-150706

(51) Int. Cl. G06K 9/32

(52) U.S. Cl. 382/298

(57) ABSTRACT

There is provided an image processing apparatus including a frequency separation unit that reduces an input image, restores the reduced input image to an image size before reduction, calculates a difference from the input image before reduction, and separates the input image into a reduced image and a difference image, an image processing unit that processes at least either one of the reduced image or the difference image, and a synthesizing processing unit that synthesizes the reduced image and the difference image, at least either one of which is image-processed, at a same image size.

### BACKGROUND

The present technology relates to an image processing apparatus, an image processing method, a program and a recording medium; in particular, the present technology easily enhances image quality with a simple configuration.

In related art, noise removal and increasing sharpness are made on an image to enhance image quality. For example, Japanese Unexamined Patent Application Publication No. 2008-294601 teaches a technique in which motion compensation is made for each block on a second still image which is continuous to a first still image in time sequence, and reliability determination is made on addition for each pixel using the first still image and the motion-compensated second still image. Addition or weighted average is made in accordance with an additional weight based on the determination result; thereby influence of noises is reduced.

### SUMMARY

When processing motion compensation for each block on a time-sequential second still image and processing addition or weighted average in accordance with an additional weight based on a reliability determination result of an addition for each pixel, as taught in Japanese Unexamined Patent Application Publication No. 2008-294601, the processing cost increases as high definition of input image increases. As a result, high speed image processing is hardly carried out. Also, when image data are temporally stored for image processing, a large scale memory or buffer is used. Moreover, for processing an image at a high speed, for example, a wide band width is used.

Therefore, it is desirable to provide an image processing apparatus and an image processing method which are capable of easily enhancing image quality with a simple configuration and a program and a recording medium thereof.

A first aspect of the present technology provides an image processing apparatus including a frequency separation unit that reduces an input image, restores the reduced input image to an image size before reduction, calculates a difference from the input image before reduction, and separates the input image into a reduced image and a difference image, an image processing unit that processes at least either one of the reduced image or the difference image, and a synthesizing processing unit that synthesizes the reduced image and the difference image, at least either one of which is image-processed, at a same image size.

In the present technology, the frequency separation unit separates the input image into the reduced image and the difference image each having a different frequency band by reducing the input image and restoring the reduced image to an image size before reduction to thereby calculate a difference from the input image before reduction. The image processing unit performs image processing on at least either one of the reduced image and the difference image. For example, the image processing unit performs image quality enhancement processing such as noise removal and sharpness enhancement on the reduced image. Also, the image processing unit estimates the noise amount for each pixel based on the input image, calculates the feature amount representing non-flatness for each pixel based on the difference image, adjusts the gain on the difference image by setting a gain coefficient based on the noise amount and the feature amount. Also, the image processing unit stores the set gain coefficient to use the stored gain coefficient for processing the following difference images. Further, the image processing unit performs coring processing on the difference image to suppress signals smaller than a threshold value and sets the threshold value based on the feature amount representing non-flatness which is calculated from the noise amount and the reduced image after image processing. The synthesizing processing unit synthesizes the reduced image and the difference image, at least either one of which is image-processed, at the same image size.

A second aspect of the present technology provides an image processing method including reducing an input image, restoring the reduced input image to an image size before reduction, calculating a difference from the input image before reduction, and separating the input image into a reduced image and a difference image, processing at least either one of the reduced image or the difference image, and synthesizing the reduced image and the difference image, at least either one of which is image-processed, at a same image size.

A third aspect of the present technology provides A program for causing a computer to execute image processing, including a sequence of reducing an input image, restoring the reduced input image to an image size before reduction, calculating a difference from the input image before reduction, and separating the input image into a reduced image and a difference image, a sequence of processing at least either one of the reduced image or the difference image, and a sequence of synthesizing the reduced image and the difference image, at least either one of which is image-processed, at a same image size.

A fourth aspect of the present technology provides a computer-readable recording medium storing a program for causing a computer to execute image processing, including a sequence of reducing an input image, restoring the reduced input image to an image size before reduction, calculating a difference from the input image before reduction, and separating the input image into a reduced image and a difference image, a sequence of processing at least either one of the reduced image or the difference image, and a sequence of synthesizing the reduced image and the difference image, at least either one of which is image-processed, at a same image size.

A fifth aspect of the present technology provides an image processing apparatus including a frequency separation unit that reduces an input image, restores the reduced input image to an image size before reduction, calculates a difference from the input image before reduction, separates the input image into a reduced image and a difference image, repeats the separation using the reduced image as the input image, and thereby generating a reduced image and a plurality of difference images, an image processing unit that processes at least either one of the reduced image or the plurality of difference images, and a synthesizing processing unit that synthesizes the reduced image and the plurality of difference images, at least either one of which is image-processed, at a same image size.

A sixth aspect of the present technology provides an image processing method including reducing an input image, restoring the reduced input image to an image size before reduction, calculating a difference from the input image before reduction, separating the input image into a reduced image and a difference image, repeating the separation using the reduced image as the input image, and thereby generating a reduced image and a plurality of difference images, processing at least either one of the reduced image or the plurality of difference images, and synthesizing the reduced image and the plurality of difference images, at least either one of which is image-processed, at a same image size.

A seventh aspect of the present technology provides a program for causing a computer to execute image processing, including a sequence of reducing an input image, restoring the reduced input image to an image size before reduction, calculating a difference from the input image before reduction, separating the input image into a reduced image and a difference image, repeating the separation using the reduced image as the input image, and thereby generating a reduced image and a plurality of difference images, a sequence of processing at least either one of the reduced image or the plurality of difference images, and a sequence of synthesizing the reduced image and the plurality of difference images, at least either one of which is image-processed, at a same image size.

An eighth aspect of the present technology provides a computer-readable recording medium storing a program for causing a computer to execute image processing, including a sequence of reducing an input image, restoring the reduced input image to an image size before reduction, calculating a difference from the input image before reduction, separating the input image into a reduced image and a difference image, repeating the separation using the reduced image as the input image, and thereby generating a reduced image and a plurality of difference images, a sequence of processing at least either one of the reduced image or the plurality of difference images, and a sequence of synthesizing the reduced image and the plurality of difference images, at least either one of which is image-processed, at a same image size.

The program of the present technology is a program, which is capable of being provided to, for example, a general-purpose computer capable of executing various kinds of programs and codes via a computer readable storing medium, for example, an optical disk, a magnetic disk, or a semiconductor memory. By providing such program in a computer readable form, processing is achieved in accordance with a program on a computer.

According to the present technology, an input image is reduced, the reduced image is restored to an image size before reduction to calculate a difference from the input image before reduction; and the input image is separated into the reduced image and the difference image each having a different frequency band. At least either one of the reduced image and the difference image is processed, and the reduced image and the difference image, at least either one of which is image-processed, are synthesized at the same image size. Accordingly, the image quality can be easily enhanced with simple configuration at low processing cost without using a large scale memory or buffer. Also image quality can be enhanced for each frequency band.

### BRIEF DESCRIPTION OF THE DRAWINGS

FIG. 1 is a diagram illustrating a basic structure of an image processing apparatus;

FIG. 2 is a flow chart illustrating a basic operation of the image processing apparatus;

FIG. 3 is a diagram illustrating a configuration of a first embodiment;

FIG. 4 is a diagram illustrating a configuration of a reducing processing section;

FIG. 5 is a flow chart illustrating an operation of the reducing processing section;

FIG. 6 is a diagram illustrating an example of reducing an input image by ½ times;

FIG. 7 is a diagram illustrating a configuration of an enlarging processing section;

FIG. 8 is a flow chart illustrating an operation of the enlarging processing section;

FIG. 9 is a diagram illustrating an example of enlarging a reduced image by 2 times;

FIG. 10 is a diagram illustrating a configuration of a difference calculating section;

FIG. 11 is an example of a relation between pixel signals generated by an image sensor and noise amount;

FIG. 12 is a diagram illustrating calculation of feature amount;

FIG. 13 is a diagram illustrating a configuration of a second embodiment;

FIG. 14 is a diagram illustrating a configuration of a third embodiment;

FIG. 15 is a diagram illustrating a configuration of a coring processing section;

FIG. 16 is a flow chart illustrating an operation of the coring processing section;

FIG. 17 is a diagram illustrating an example of coring characteristics;

FIG. 18 is a diagram illustrating a configuration of a fourth embodiment;

FIG. 19 is a diagram illustrating a configuration of a fifth embodiment; and

FIG. 20 is a diagram illustrating an example of hardware configuration of a computer.

### DETAILED DESCRIPTION OF THE EMBODIMENTS

Embodiments for implementing the present technology will be described below. The description will be made in the following order.

1. Basic configuration and basic operation of image processing apparatus

2. First embodiment

3. Second embodiment

4. Third embodiment

5. Fourth embodiment

6. Fifth embodiment

7. Carrying out processing with program

### 1. Basic Configuration and Basic Operation of Image Processing Apparatus

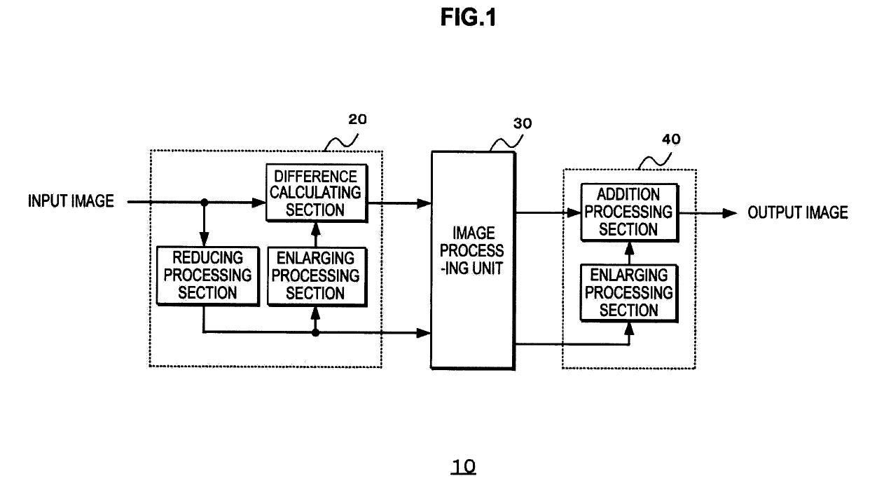

FIG. 1 illustrates a basic configuration of an image processing apparatus according to an embodiment of the present technology. An image processing apparatus 10 includes a frequency separation unit 20, an image processing unit 30 and a synthesizing processing unit 40. The frequency separation unit 20 reduces an input image, restores the reduced image to an image size before reduction to calculate a difference from the input image before reduction, and separates the input image into a reduced image and a difference image each having a different frequency band.

The image processing unit 30 processes at least either one of the reduced image and the difference image to enhance the image quality. The synthesizing processing unit 40 adjusts the size of the reduced image and the difference image, at least either one of which is image-processed, to the same image size, and synthesizes the two images to generate an output image.

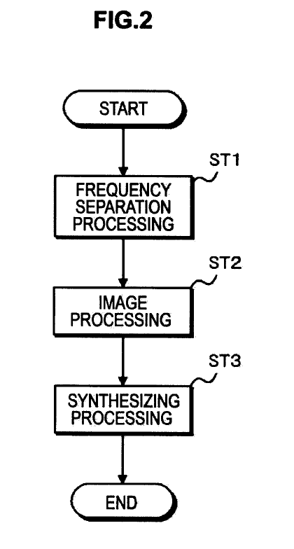

FIG. 2 is a flow chart illustrating a basic operation of the image processing apparatus. In step ST1, the image processing apparatus 10 separates the frequency. The image processing apparatus 10 reduces the size of an input image, restores the size of the reduced image to an image size before reduction and calculates a difference between the reduced image and the input image before reduction, and separates the input image into the reduced image and the difference image each having a different frequency band, and proceeds to step ST2.

In step ST2, the image processing apparatus 10 processes images. The image processing apparatus 10 processes at least either one of the reduced image and the difference image to enhance the image quality, and proceeds to step ST3.

In step ST3, the image processing apparatus 10 performs synthesizing processing. The image processing apparatus 10 adjusts the size of the reduced image and the difference image, at least either of which is image-processed, to the same image size, and synthesizes the two images to generate the output image.

Now, examples of configuration and detailed operation in first-fifth embodiments of the image processing apparatus will be described below. In the first-fifth embodiments, a case in which each of the reduced image and the difference image is processed, and the processed reduced image and the processed difference image are synthesized at an image size of the difference image to generate an output image, will be described.

### 2. First Embodiment

### Configuration of Image Processing Apparatus

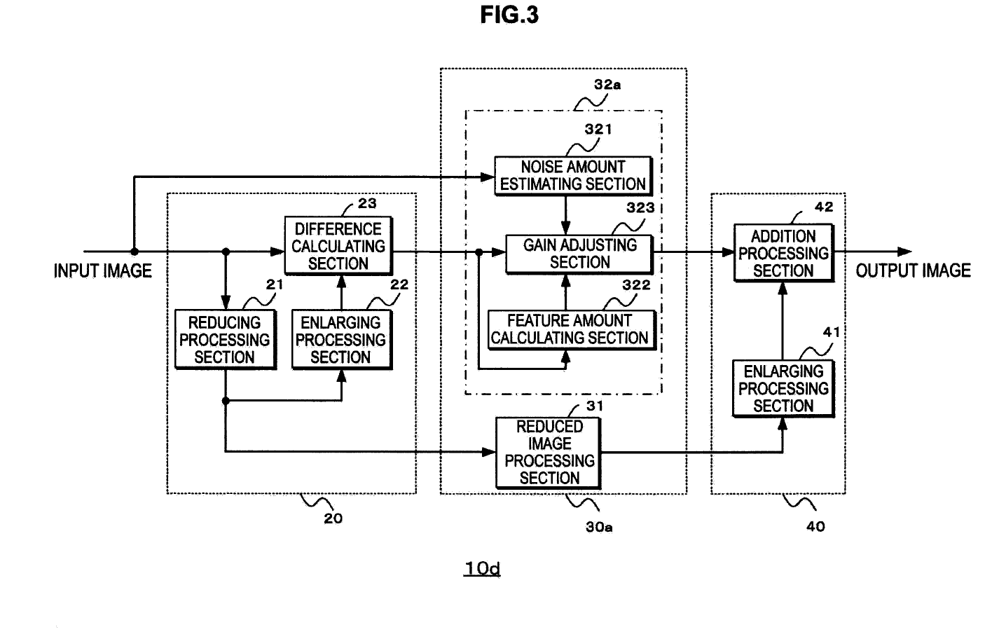

FIG. 3 illustrates a configuration of a first embodiment of the present technology. The frequency separation unit 20 of an image processing apparatus 10a includes a reducing processing section 21, an enlarging processing section 22 and a difference calculating section 23. An image processing unit 30a of the image processing apparatus 10a includes a reduced image processing section 31 and a difference image handling unit 32a. The synthesizing processing unit 40 of the image processing apparatus 10a includes an enlarging processing section 41 and an addition processing section 42. The difference image handling unit 32a includes a noise amount estimating section 321, a feature amount calculating section 322 and a gain adjusting section 323.

The reducing processing section 21 of the frequency separation unit 20 reduces the size of the input image. The reducing processing section 21 reduces the size of the input image to generate a reduced image in which high-frequency component of the input image is eliminated in accordance with a reduction ratio. The reducing processing section 21 outputs the generated reduced image to the enlarging processing section 22 and the image processing unit 30a.

The enlarging processing section 22 enlarges the reduced image to restore the reduced image to the size of the input image, and outputs the enlarged image to the difference calculating section 23.

The difference calculating section 23 calculates a difference between the input image and the reduced image which is enlarged to the image size before reduction and generates the difference image. Here, even when the reduced image is enlarged to the image size before reduction, since the high-frequency component of the input image is being eliminated, the difference image results in a high frequency image which represents the high-frequency component of the input image. The difference calculating section 23 outputs the difference image representing the high-frequency component of the input image to the difference image handling unit 32a.

The reduced image processing section 31 enhances the quality of the reduced image. The reduced image processing section 31 removes noises and adjusts the sharpness of the reduced image to enhance the quality thereof, and outputs the reduced image to the synthesizing processing unit 40.

The noise amount estimating section 321 of the difference image handling unit 32a estimates the noise amount in the input image for each pixel, and outputs an estimation result to the gain adjusting section 323.

The feature amount calculating section 322 calculates feature amount for each pixel using the difference image. The feature amount calculating section 322 calculates, for example, the dispersion using adjacent pixels for each pixel to obtain a feature amount which represents non-flatness. The feature amount calculating section 322 outputs the calculated feature amount to the gain adjusting section 323.

The gain adjusting section 323, which is a difference image processing section that processes the difference image, adjusts the signal level of the difference image for each pixel using the noise amount estimated by the noise amount estimating section 321 and the feature amount calculated by the feature amount calculating section 322, and outputs the same to the synthesizing processing unit 40.

The enlarging processing section 41 of the synthesizing processing unit 40 enlarges the reduced image with enhanced quality, which is supplied from the reduced image processing section 31, to restore the size of the input image to the same image size as the difference image, and outputs the enlarged image to the addition processing section 42.

The addition processing section 42 adds the enlarged image after image quality enhancement, which is supplied from the enlarging processing section 41, to the difference image with adjusted gain, which is supplied from the difference image handling unit 32a, to generate an output image.

### Configuration and Operation of Each Section

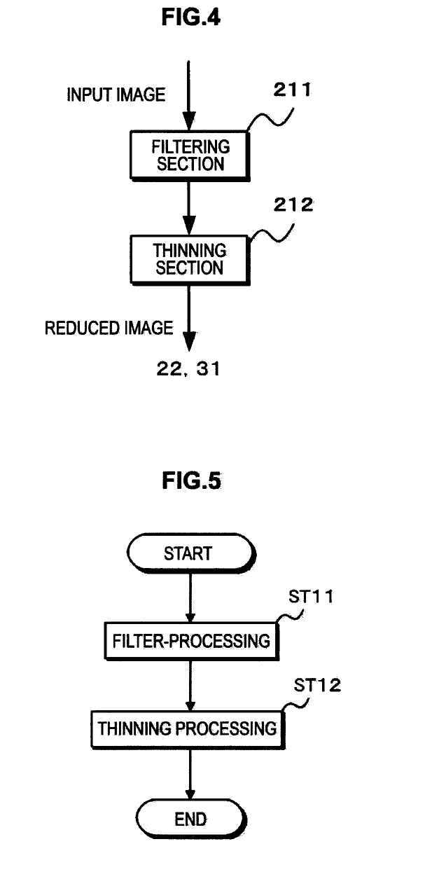

Subsequently, a configuration and an operation of each section will be described. FIG. 4 illustrates a configuration of the reducing processing section 21. The reducing processing section 21 includes a filtering section 211 and a thinning section 212.

The filtering section 211 filters the input image. The filtering section 211 performs low-pass filtering on the input image in accordance with the reduction ratio to reduce the size of the input image and attenuate frequency components of the input image to be eliminated from the reduced image. After filter-processing, the filtering section 211 outputs the input image to the thinning section 212.

The thinning section 212 thins pixels from the filter-processed input image in accordance with the reduction ratio and generates a reduced image at a desired reduction ratio.

FIG. 5 is a flow chart illustrating an operation of the reducing processing section 21. In step ST11, the reducing processing section 21 performs filter-processing. The reducing processing section 21 performs low-pass filtering on the input image in accordance with the reduction ratio as described above, and proceeds to step ST12.

In step ST12, the reducing processing section 21 performs thinning processing. The reducing processing section 21 performs pixel thinning processing on the filter-processed input image in accordance with the reduction ratio to generate a reduced image; and terminates the reduction processing.

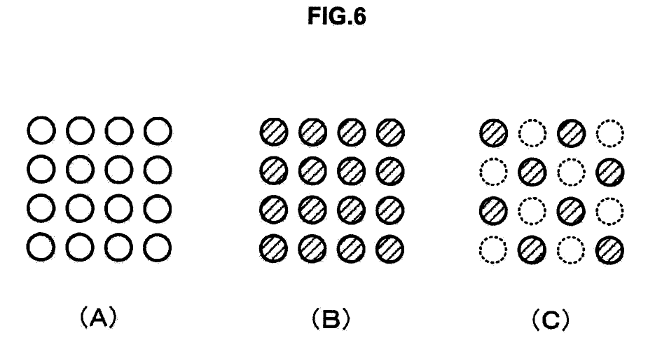

FIG. 6 illustrates an example of reducing the size of the input image by ½ times. FIG. 6(A) illustrates a partial area of the input image; for example, an area of 4 pixels×4 pixels. The reducing processing section 21 performs filter-processing on the input image and generates a pixel signal for each pixel position in the input image as shown in FIG. 6(B). The reducing processing section 21 thins 1 pixel at intervals of 1 pixel on the filter-processed input image to generate a reduced image in which input image is reduced by ½ times as shown in FIG. 6(C). In FIG. 6(C), thinned pixels are indicated with broken line.

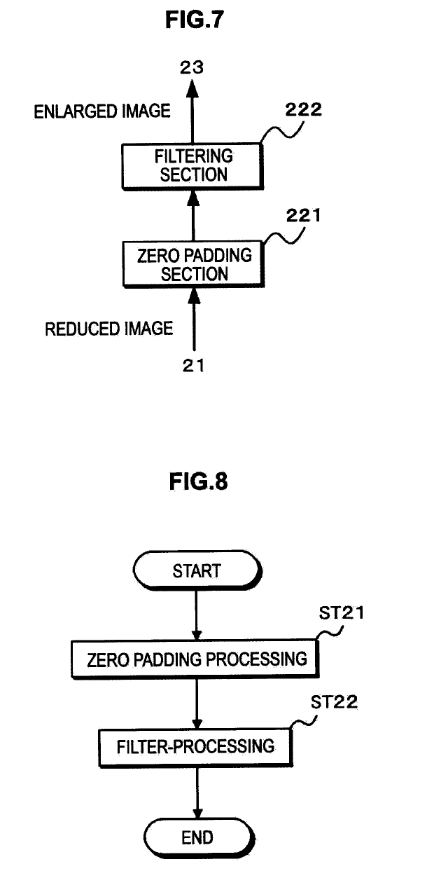

FIG. 7 illustrates a configuration of the enlarging processing section 22. The enlarging processing section 22 includes a zero padding section 221 and a filtering section 222.

The zero padding section 221 adds zero data among the pixels in accordance with the enlargement ratio. The zero padding section 221 adds zero data among the pixels in the reduced image in accordance with the enlargement ratio to generate, for example, an enlarged image of the same size (number of pixels) as the input image; and outputs the same to the filtering section 222.

The filtering section 222 performs filtering processing on the enlarged image. The filtering section 222 attenuates undesired frequency components, for example, folding aliasing or the like which are caused from the enlargement of the reduced image.

FIG. 8 is a flow chart illustrating an operation of the enlarging processing section 22. In step ST21, the enlarging processing section 22 performs zero padding processing. The enlarging processing section 22 adds zero data among the pixels in the reduced image in accordance with the enlargement ratio as described above to generate an enlarged image, and then proceeds to step ST22.

In step ST22, the enlarging processing section 22 performs filter-processing. The enlarging processing section 22 filters the enlarged image to attenuate undesired frequency components; and terminates the enlargement processing.

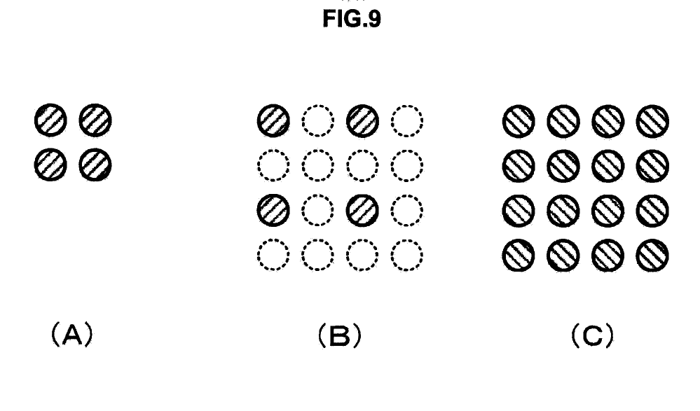

FIG. 9 illustrates an example of enlarging the reduced image by 2 times. FIG. 9(A) illustrates a partial area of the reduced image; for example, an area of 2 pixels×2 pixels. The enlarging processing section 22 adds zero data among the pixels in the reduced image to generate an enlarged image in which the number of pixels are increased by 2 times in a horizontal direction and a vertical direction respectively as shown in FIG. 9(B). The enlarging processing section 22 performs filter-processing on the enlarged image and generates the enlarged image in which the reduced image is increased by 2 times as shown in FIG. 9(C). In FIG. 9(B), pixels of zero data are indicated with broken line.

The reducing processing section 21 generates the reduced image at the reduction ratio of (1/integer) times; the enlarging processing section 22 generates the enlarged image at the enlargement ratio of integer times. However, the reduction ratio and the enlargement ratio are not limited to (1/integer) times or integer times. The reducing processing section 21 and the enlarging processing section 22 may combine enlargement processing and reduction processing respectively to generate a reduced image or an enlarged image of other magnification. For example, when reducing the size by ⅗ times, after enlarging an image by 3 times, the image is reduced by ⅕ times to generate a reduced image. Likewise, when generating an enlarged image of 5/3 times, after enlarging an image by 5 times and then the image is reduced by ⅓ times.

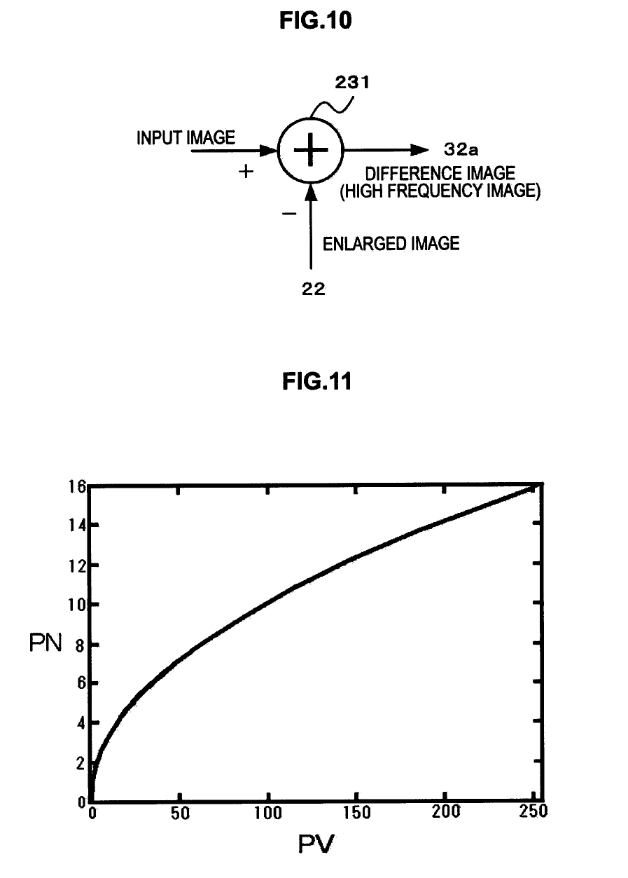

FIG. 10 illustrates a configuration of the difference calculating section 23. The difference calculating section 23 is configured by using a subtracter 231. The subtracter 231 subtracts the enlarged reduced image from the input image to generate a difference image which represents high-frequency component of the input image.

The reduced image processing section 31 of the image processing unit 30a is configured by using a filter or the like; for example, frequency band restriction is made to remove noises from the image signal of the reduced image. Also, edge enhancement or the like is made by using a filter of “Roberts”, “Prewitt”, “Sobel” or the like to enhance the sharpness of the reduced image.

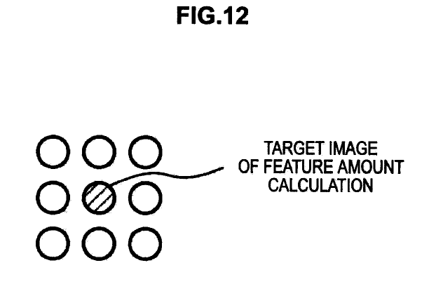

The noise amount estimating section 321 of the difference image handling unit 32a estimates the noise amount of the input image for each pixel. The noise amount of image sensor correlates with statistic distribution of the number of photons detected at a constant exposure level, and it is known that the correlation basically agrees with Poisson distribution. FIG. 11 illustrates an example of a relation between pixel signal PV generated by an image sensor and the noise amount PN. The noise amount PN indicates a standard deviation of noise signals.

The relation between the signal level of the pixel signal and the noise amount shown in FIG. 11 is represented by Formula (1). In Formula (1), each of Ka and Kb is coefficients depending on the image sensor.

PN(x)=Ka\sqrt{PS(x)}+Kb (1)

Therefore, by previously obtaining the coefficients Ka and Kb, the noise amount of the input image can be estimated for each pixel. As for estimation of the noise amount, the noise amount may be estimated by calculating Formula (1) based on the signal level for each pixel in the input image; or by creating a table based on Formula (1), the noise amount corresponding to the signal level in the input image may be obtained from the table for each pixel. When the table is used, by creating the table after measuring the noise amount corresponding to the signal level of the pixel signal, even when the correlation is out of the Poisson distribution, the estimation is easily achieved. Thus, the noise amount estimating section 321 estimates the noise amount PN based on the pixel signal for each pixel in the input image.

The feature amount calculating section 322 calculates the feature amount for each pixel using pixel signals of adjacent pixels. For example, the feature amount calculating section 322 calculates dispersion and pseudo dispersion by using pixel signals of adjacent pixels to obtain a feature amount PU. For example, a case, in which the feature amount is calculated with respect to a pixel as the target of the feature amount calculation by using pixel signals of 8 adjacent pixels as shown in FIG. 12, will be described. In FIG. 12, a pixel as the target of feature amount calculation is represented with slant lines.

When the dispersion is used as the feature amount, by calculating based on Formula (2) using pixel signals PV of total 9 pixels, the dispersion Var is obtained. “Ave” represents an average value of pixel signals of 9 pixels as shown in Formula (3).

$$\begin{matrix}Var = \frac{\sum {PV}^{2}}{9} - {Ave}^{2} & ( 2 ) \\ Ave = \frac{\sum PV}{9} & ( 3 )\end{matrix}$$

When pseudo dispersion is used as the feature amount, pseudo dispersion PseudoVar can be obtained by calculating Formula (4) using pixel signals PV of total 9 pixels. The pseudo dispersion represents a square value of an average of absolute difference of averaged value between an averaged value of pixel signals including adjacent pixels and pixel signals of pixels including of adjacent pixels. “Ave” represents an averaged value of pixel signals of 9 pixels as shown in Formula (3).

$$Pseudo Var = {( \frac{\sum \vert PV - Ave \vert}{9} )}^{2} \qquad ( 4 )$$

Thus, the feature amount calculating section 322 calculates the dispersion or the pseudo dispersion using pixel signals of adjacent pixels to obtain the dispersion or the pseudo dispersion as the feature amount PU.

The gain adjusting section 323 adjusts the gain of the difference image based on the noise amount determined by the noise amount estimating section 321 and the feature amount calculated by the feature amount calculating section 322. Defining a pixel signal of the J-th pixel in the difference image as PV(j); a noise amount of the J-th pixel in the input image as PN(j); and a feature amount of the J-th pixel in the difference image as PU(j), the gain adjusting section 323 calculates Formula (5) to generate a pixel signal PVc(j) with adjusted gain.

$$PVc ( j ) = \frac{{PU ( j )}^{2}}{{PN ( j )}^{2} + {PU ( j )}^{2}} \times PV ( j ) \qquad ( 5 )$$

The enlarging processing section 41 of the synthesizing processing unit 40 is configured same as the enlarging processing section 22. By operating same as the enlarging processing section 22, the reduced image after image quality enhancement is enlarged to an image size of the difference image. That is, the enlarging processing section 41 generates a low frequency image after image quality enhancement and outputs the same to the addition processing section 42.

The addition processing section 42 adds the image, which is supplied from the enlarging processing section 41, to the difference image, which is supplied from the gain adjusting section 323 of the difference image handling unit 32a, to generate an output image for each pixel, in which noises of high-frequency component are eliminated and the image quality in low pass component is enhanced, and outputs the same.

As described above, according to the first embodiment, the size of an input image is once reduced, and then the same is enlarged to the image size before reduction to generate a high frequency image as a difference image between the an enlarged image and an input image. Also, the signal level of the high frequency image is adjusted in accordance with the feature amount representing a noise amount or non-flatness which is estimated for each pixel of the high frequency image. Also, a reduced image, which is a low frequency image of the input image by reducing the size of the input image, is generated. After enhancing the image quality using the reduced image, the image after image quality enhancement is enlarged to an image size of the difference image, and is synthesized with the difference image after signal level adjustment. Accordingly, the image quality can be easily enhanced with simple configuration at low processing cost without using a large scale memory or buffer. Also image quality can be enhanced for each frequency band.

### 3. Second Embodiment

Subsequently, a second embodiment will be described. In the second embodiment, an image processing apparatus 10b, which is capable of enhancing the image quality also in a time direction, will be described.

### Configuration of Image Processing Apparatus

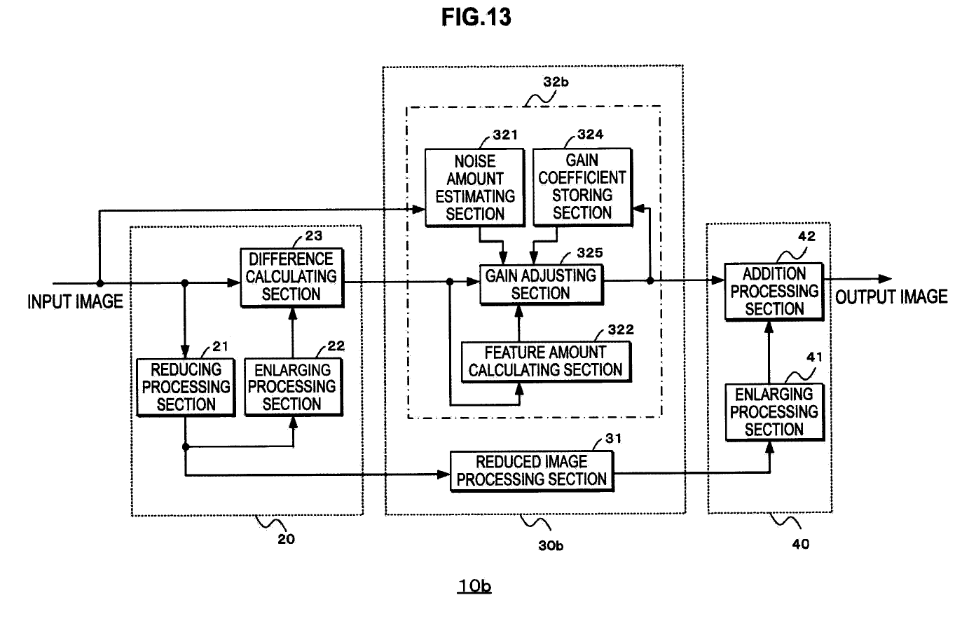

FIG. 13 illustrates a configuration of the second embodiment of the present technology. The image processing apparatus 10b includes a frequency separation unit 20 and a synthesizing processing unit 40 same as the first embodiment. The image processing unit 30b of the image processing apparatus 10b of the second embodiment includes a reduced image processing section 31 and a difference image handling unit 32b. Further, the difference image handling unit 32b includes a noise amount estimating section 321, a feature amount calculating section 322, a gain coefficient storing section 324 and a gain adjusting section 325.

A reducing processing section 21 of the frequency separation unit 20 reduces the size of an input image. The reducing processing section 21 reduces the input image to thereby generate a reduced image in which high-frequency component of the input image is eliminated in accordance with a reduction ratio. The reducing processing section 21 outputs the generated reduced image to the enlarging processing section 22 and the image processing unit 30b.

The enlarging processing section 22 enlarges the reduced image to restore the reduced image to the size of the input image, and outputs the enlarged image to the difference calculating section 23.

The difference calculating section 23 calculates a difference between the input image and the reduced image which is enlarged to the image size before reduction and generates a difference image. Here, even when the reduced image is enlarged to the image size before reduction, since the high-frequency component of the input image is being eliminated, the difference image results in a high frequency image which represents a high-frequency component of the input image. The difference calculating section 23 outputs the difference image representing the high-frequency component of the input image to the difference image handling unit 32b.

The reduced image processing section 31 enhances the quality of the reduced image. The reduced image processing section 31 removes noises and adjusts the sharpness of the reduced image to enhance the quality thereof, and outputs the reduced image to the synthesizing processing unit 40.

The noise amount estimating section 321 of the difference image handling unit 32b estimates the noise amount in the input image for each pixel, and outputs an estimation result to the gain adjusting section 325.

The feature amount calculating section 322 calculates feature amount for each pixel using the difference image. The feature amount calculating section 322 calculates, for example, the dispersion using adjacent pixels for each pixel to obtain a feature amount which represents non-flatness. The feature amount calculating section 322 outputs the calculated feature amount to the gain adjusting section 325.

The gain adjusting section 325, which is a difference image processing section that processes the difference image, adjusts the signal level of the difference image for each pixel using the noise amount estimated by the noise amount estimating section 321 and the feature amount calculated by the feature amount calculating section 322, and a previous gain coefficient stored in the gain coefficient storing section 324. The gain adjusting section 325 outputs the difference image after signal level adjustment to the synthesizing processing unit 40. The gain adjusting section 325 outputs the gain coefficient, which is used for adjusting the signal level of the difference image, to the gain coefficient storing section 324.

The gain coefficient storing section 324 stores the gain coefficient supplied from the gain adjusting section 325. The gain coefficient storing section 324 outputs the stored gain coefficient to the gain adjusting section 325.

The enlarging processing section 41 of the synthesizing processing unit 40 enlarges the reduced image with enhanced quality, which is supplied from the reduced image processing section 31, to restore the size of the input image to the same image size as the difference image, and outputs the enlarged image to the addition processing section 42.

The addition processing section 42 adds the enlarged image after image quality enhancement, which is supplied from the enlarging processing section 41, to the difference image with adjusted gain, which is supplied from the difference image handling unit 32b, to generate an output image.

### Configuration and Operation of Each Section

Subsequently, a configuration and an operation of each section will be described. The reducing processing section 21 is configured as illustrated in FIG. 4 which has been described above, and performs the operation illustrated in FIG. 5 to generate the reduced image. The enlarging processing section 22 is configured as illustrated in FIG. 7, which has been described above, to perform the operation illustrated in FIG. 8 to generate the enlarged image. The difference calculating section 23 is configured as illustrated in FIG. 10, which has been described above, to subtract the reduced image, which is enlarged by the enlarging processing section 22, from the input image to generate the difference image representing the high-frequency component of the input image.

The reduced image processing section 31 removes noises from the reduced image and enhances the edge as described above to enhance the image quality of the reduced image.

The noise amount estimating section 321 of the difference image handling unit 32b estimates the noise amount of the input image by calculating Formula (1) or using the table as described above. The feature amount calculating section 322 calculates the dispersion or the pseudo dispersion for each pixel by using pixel signals of adjacent pixels to obtain the calculated dispersion or pseudo dispersion as the feature amount.

The gain adjusting section 325 adjusts the gain of the difference image based on the noise amount estimated by the noise amount estimating section 321, the feature amount calculated by the feature amount calculating section 322, and the gain coefficient stored in the gain coefficient storing section 324. Here, the pixel signal at the J-th pixel of the difference image is defined as PV(j); the noise estimated amount of the J-th pixel of the input image is defined as PN(j); and the feature amount of the J-th pixel of the difference image is defined as PU(j). Also, the gain coefficient which is used for adjusting the gain of the J-th pixel in the previous difference image, for example, by one frame is defined as CFpr(j). The gain adjusting section 325 calculates formulas (6) and (7) to generate a pixel signal PVc(j) after adjusting the gain.

$$\begin{matrix}PVc ( j ) = CF ( j ) \times PV ( j ) & ( 6 ) \\ CF ( j ) = \frac{\frac{{PU ( j )}^{2}}{{PN ( j )}^{2} + {PU ( j )}^{2}} + {CF}_{pr} ( j )}{2} & ( 7 )\end{matrix}$$

The gain adjusting section 325 also causes the gain coefficient storing section 324 to store the gain coefficient CF(j) which is used for adjusting the gain of the difference image.

The enlarging processing section 41 of the synthesizing processing unit 40 is configured same as the enlarging processing section 22. By operating same as the enlarging processing section 22, a reduced image after image quality enhancement is enlarged to an image size of the difference image. That is, the enlarging processing section 41 generates a low frequency image after image quality enhancement and outputs the same to the addition processing section 42.

The addition processing section 42 adds the image, which is supplied from the enlarging processing section 41, to the difference image, which is supplied from the gain adjusting section 325 of the difference image handling unit 32b, for each pixel, to generate an output image, in which noises of high-frequency component are eliminated and image quality in low pass components is enhanced, outputs the same.

As described above, according to the second embodiment, different from the first embodiment, the signal level of the high-frequency component image is adjusted in accordance with the noise estimated amount for each pixel of the high-frequency component image, the feature amount of the high-frequency component image and the previous gain coefficient. Therefore, the image quality can be easily enhanced with a simple configuration at a low processing cost without providing a large scale memory or buffer. Also, the image quality can be enhanced for each frequency band. Moreover, since a previous gain coefficient is used, an output image can be stably generated with respect to a time direction.

### 4. Third Embodiment

Subsequently, a third embodiment will be described. In the third embodiment, an image processing apparatus 10c that reduces influence of noises by carrying out coring on the difference image will be described.

### Configuration of Image Processing Apparatus

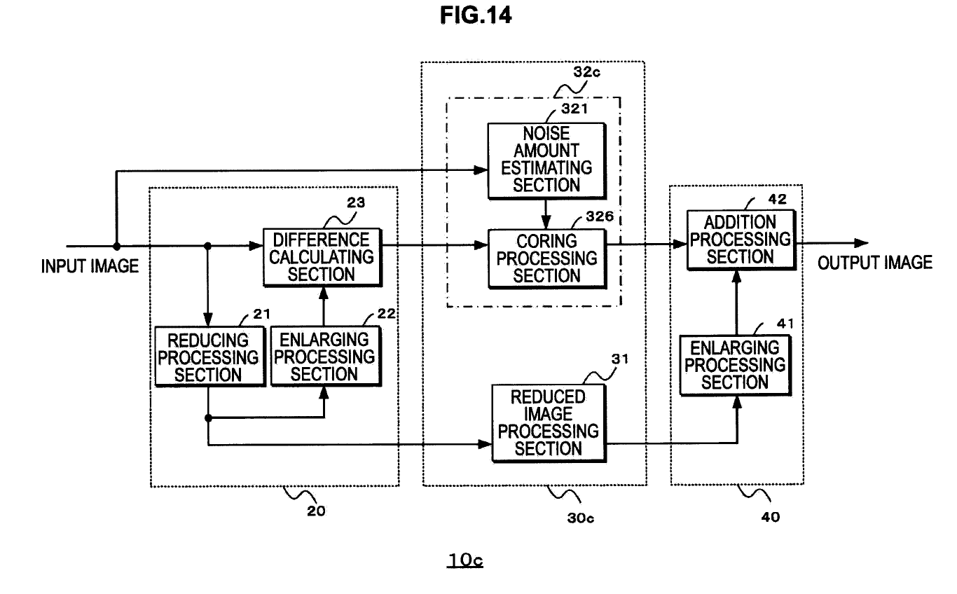

FIG. 14 illustrates a configuration of the third embodiment of the present technology. The image processing apparatus 10c includes a frequency separation unit 20 and a synthesizing processing unit 40 same as the first embodiment. The image processing unit 30c of the image processing apparatus 10c of the third embodiment includes a reduced image processing section 31 and a difference image handling unit 32c. The difference image handling unit 32c includes a noise amount estimating section 321 and a coring processing section 326.

The reducing processing section 21 of the frequency separation unit 20 reduces the size of the input image. The reducing processing section 21 reduces the size of the input image to generate a reduced image in which high-frequency component of the input image is eliminated in accordance with a reduction ratio. The reducing processing section 21 outputs the generated reduced image to the enlarging processing section 22 and the image processing unit 30c.

The enlarging processing section 22 enlarges the reduced image to restore the reduced image to the size of the input image, and outputs the enlarged image to the difference calculating section 23.

The difference calculating section 23 calculates a difference between the input image and the reduced image which is enlarged to the image size before reduction and generates the difference image. Here, even when the reduced image is enlarged to the image size before reduction, since the high-frequency component of the input image is being eliminated, the difference image results in a high frequency image which represents high-frequency component of the input image. The difference calculating section 23 outputs the difference image representing the high-frequency component of the input image to the difference image handling unit 32c.

The reduced image processing section 31 enhances the quality of the reduced image. The reduced image processing section 31 removes noises and adjusts the sharpness of the reduced image to enhance the quality thereof, and outputs the reduced image to the synthesizing processing unit 40.

The noise amount estimating section 321 of the difference image handling unit 32c estimates the noise amount in the input image for each pixel, and outputs an estimation result to the coring processing section 326.

The coring processing section 326, which is a difference image processing section performing image processing on the difference image, sets a threshold value based on the noise amount estimated by the noise amount estimating section 321. The coring processing section 326 adjusts the signal level of the difference image for each pixel in accordance with the set threshold value and coring characteristics, and outputs the same to the synthesizing processing unit 40.

The enlarging processing section 41 of the synthesizing processing unit 40 enlarges the reduced image with enhanced quality, which is supplied from the reduced image processing section 31, to restore the size of the input image to the same image size as the difference image, and outputs the enlarged image to the addition processing section 42.

The addition processing section 42 adds the enlarged image after image quality enhancement, which is supplied from the enlarging processing section 41, to the difference image with adjusted gain, which is supplied from the difference image handling unit 32c, to generate an output image.

### Configuration and Operation of Each Section

Subsequently, a configuration and an operation of each section will be described. The reducing processing section 21 is configured as illustrated in FIG. 4, which has been described above, and performs the operation illustrated in FIG. 5 to generate a reduced image. The enlarging processing section 22 is configured as illustrated in FIG. 7, which has been described above, and performs the operation illustrated in FIG. 8 to generate an enlarged image. The difference calculating section 23 is configured as illustrated in FIG. 10, which has been described above, and subtracts the reduced image which is enlarged by the enlarging processing section 22 from the input image to generate a difference image representing the high-frequency component of the input image.

The reduced image processing section 31 removes noises from the reduced image and enhances the edge as described above to enhance image quality of the reduced image.

The noise amount estimating section 321 of the difference image handling unit 32c estimates the noise amount of the input image using the calculation shown in Formula (1) or a table as described above.

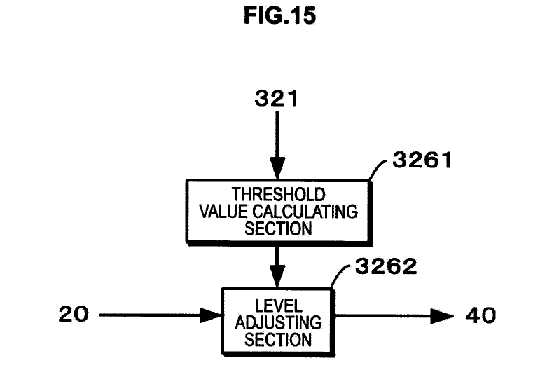

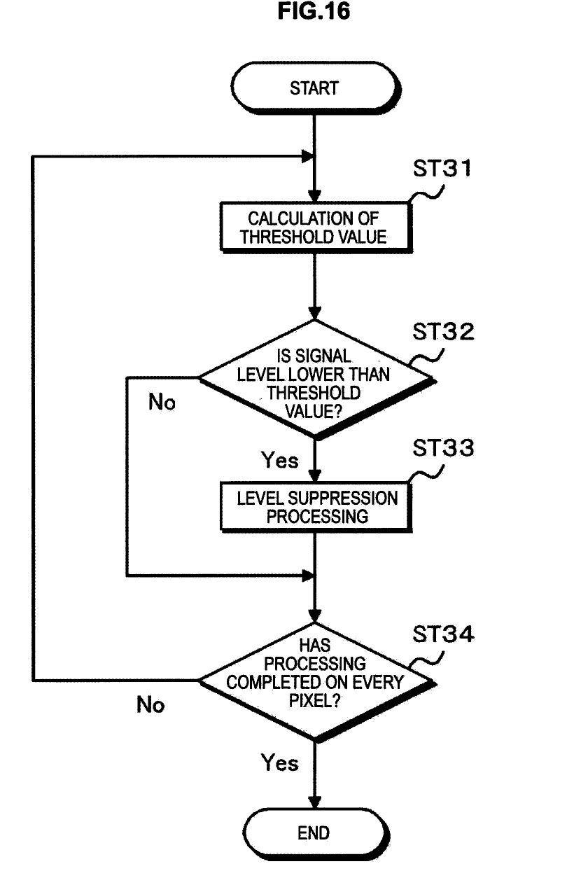

The coring processing section 326 sets a threshold value in accordance with the noise amount of each pixel, and adjusts the signal level of the difference image based on the set threshold value and a coring curve. FIG. 15 illustrates a configuration of the coring processing section 326. The coring processing section 326 includes a threshold value calculating section 3261 and a level adjusting section 3262.

The threshold value calculating section 3261 calculates the threshold value of each pixel based on the noise amount estimated by the noise amount estimating section 321. The threshold value calculating section 3261 has a table representing, for example, a relation between the noise amount and the threshold value; and by using the table, calculates the threshold value in accordance with the noise amount. The threshold value calculating section 3261 outputs the calculated threshold value to the level adjusting section 3262.

The level adjusting section 3262 adjusts the signal level of the high-frequency component image using the coring curve. When the signal level of the pixel signal is small, the level adjusting section 3262 determines the pixel signal as a noise constituent and suppresses the signal. The level adjusting section 3262 uses the threshold value calculated by the threshold value calculating section 3261 as a criteria for determining whether the pixel signal is a noise constituent or not. When the signal level of the pixel signal of the difference image is smaller than the threshold value, the level adjusting section 3262 determines the pixel signal as a noise constituent and suppresses the signal level. When the signal level of the pixel signal of the difference image is larger than the threshold value, the level adjusting section 3262 outputs the pixel signal without suppressing the signal level.

FIG. 16 is a flow chart illustrating an operation of the coring processing section 326. In step ST31, the coring processing section 326 calculates the threshold value. The coring processing section 326 obtains the noise amount of an image to be level-adjusted from the noise amount estimating section 321. The coring processing section 326 sets the threshold value in accordance with the obtained noise amount, and proceeds to step ST32.

In step ST32, the coring processing section 326 determines if the signal level is equal to the threshold value or less. The coring processing section 326 determines if the signal level of the pixel signal is smaller than the threshold value for each pixel. When the pixel signal is smaller than the threshold value, the coring processing section 326 proceeds to step ST33; when the pixel signal is larger than the threshold value, the coring processing section 326 proceeds to step ST34.

In step ST33, the coring processing section 326 performs level suppression processing. The coring processing section 326 suppresses the signal level of the pixel signal, and proceeds to step ST34.

In step ST34, the coring processing section 326 determines if the processing is completed on every pixel. When any pixel on which coring processing is not made remains, the coring processing section 326 returns to step ST31, and repeats the processing on a new pixel from step ST31. When the coring processing is completed on every pixel, the coring processing section 326 terminates the processing.

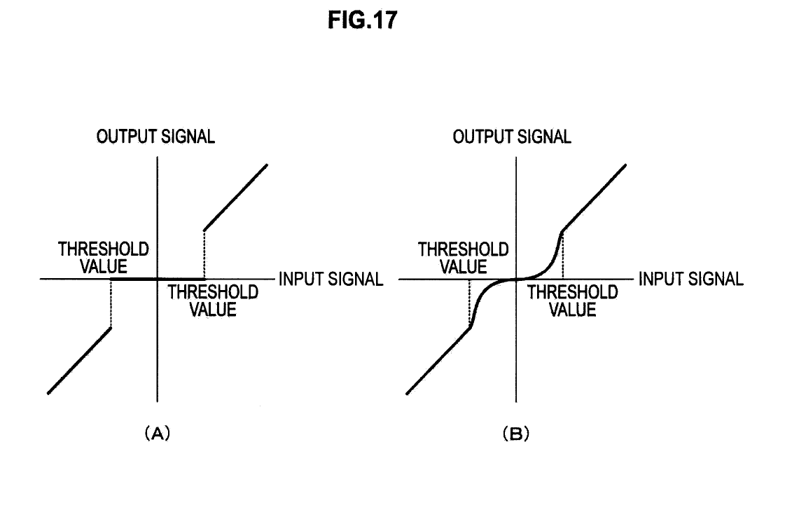

The coring processing section 326 suppresses the signal level in accordance with the coring characteristics based on the signal level of the input signal, and generates an output signal. For example, in the case of the coring characteristics shown in FIG. 17, when the noise amount is small, the coring processing section 326 sets a small level threshold value, and when the noise amount is large, a large level threshold value is set. By adjusting the signal level based on such coring characteristics, since the signal level smaller the threshold value is suppressed as noises, the difference image with little noises can be generated. When the noise amount is large, since a large level threshold value is set to increase the range of the signal level to be determined as noise, noises are reliably reduced.

FIG. 17(A) illustrates the case in which, when the signal level of the input signal is within the range of threshold value, the signal level is set to “0”. In the case where the coring processing is made using the characteristics shown in FIG. 17(A), when the signal level of the input signal is close to the threshold value, the signal level of the output signal changes largely. Therefore, the coring characteristics shown in FIG. 17(B) may be set to thereby reduce the changes of the output signal in signal level when the signal level of the input signal is close to the threshold value.

The enlarging processing section 41 of the synthesizing processing unit 40 is configured same as the enlarging processing section 22. By performing the same operation as the enlarging processing section 22, the reduced image after image quality enhancement is enlarged to the image size of the difference image. That is, a low frequency image after image quality enhancement is generated and output to the addition processing section 42.

The addition processing section 42 adds the image supplied from the enlarging processing section 41 and the difference image supplied from the coring processing section 326 of the difference image handling unit 32c for each pixel, to generate an output image, in which noises of high-frequency component are removed and the image quality of low-frequency component is enhanced, and is output.

As described above, according to the third embodiment, different from the first and second embodiments, the coring processing is made on the image of high-frequency component in accordance with the noise amount which is estimated for each pixel of the high-frequency component image and the signal level of the high-frequency component image. Accordingly, it is possible to easily enhance the image quality with a simple configuration at a low processing cost without providing a large scale memory or buffer. Also, it is possible to enhance the image quality for each frequency band. Moreover, since high-frequency components with a small signal level are suppressed as noises, the output image with a satisfactory image quality is generated.

### 5. Fourth Embodiment

Subsequently, a fourth embodiment will be described. In the fourth embodiment, coring processing is made on an image of high-frequency component to reduce influences of noises. Also, in the coring processing, a threshold value is adjusted based on a feature amount which is calculated using an enlarged reduced image of low-frequency component after image quality adjustment of low-frequency component. An image processing apparatus 10d which performs the above processing will be described.

### Configuration of Image Processing Apparatus

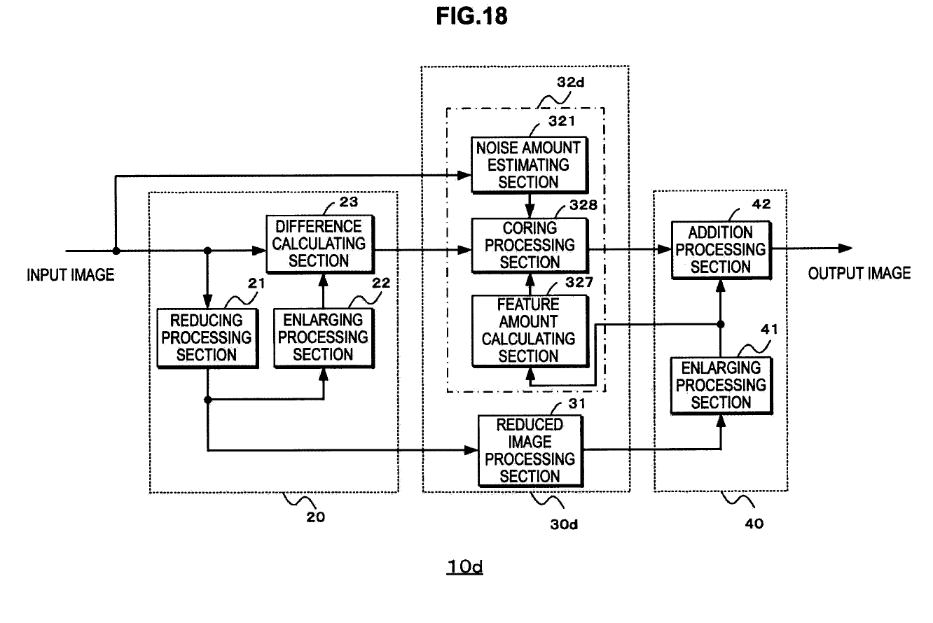

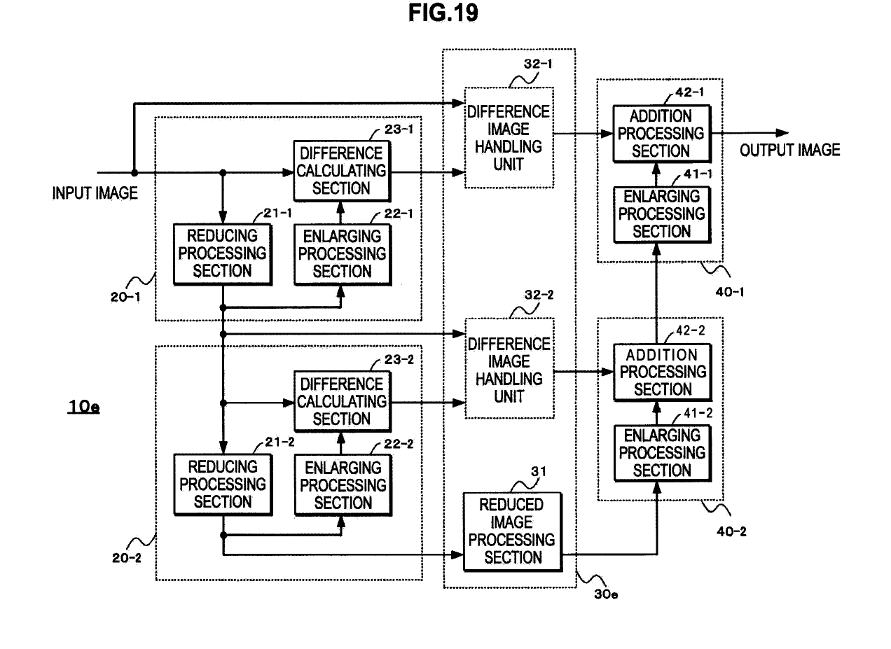

FIG. 18 illustrates a configuration of the fourth embodiment of the present technology. The image processing apparatus 10d includes a frequency separation unit 20 and a synthesizing processing unit 40 same as the third embodiment. Also, the image processing unit 30d of the image processing apparatus 10d of the fourth embodiment includes a reduced image processing section 31 and a difference image handling unit 32d. Further, the difference image handling unit 32d includes a noise amount estimating section 321, a feature amount calculating section 327 and a coring processing section 328.

The reducing processing section 21 of the frequency separation unit 20 reduces the size of the input image. The reducing processing section 21 reduces the size of the input image to generate a reduced image in which high-frequency component of the input image is eliminated in accordance with a reduction ratio. The reducing processing section 21 outputs the generated reduced image to the enlarging processing section 22 and the image processing unit 30d.

The enlarging processing section 22 enlarges the reduced image to restore the reduced image to the size of the input image, and outputs the enlarged image to the difference calculating section 23.

The difference calculating section 23 calculates a difference between the input image and the reduced image which is enlarged to the image size before reduction and generates the difference image. Here, even when the reduced image is enlarged to the image size before reduction, since the high-frequency component of the input image is being eliminated, the difference image results in a high frequency image which represents high-frequency component of the input image. The difference calculating section 23 outputs the difference image representing the high-frequency component of the input image to the difference image handling unit 32d.

The reduced image processing section 31 enhances the quality of the reduced image. The reduced image processing section 31 removes noises and adjusts the sharpness of the reduced image to enhance the quality thereof, and outputs the reduced image to the synthesizing processing unit 40.

The noise amount estimating section 321 of the difference image handling unit 32d estimates the noise amount in the input image, and outputs an estimation result to the coring processing section 328.

The feature amount calculating section 327 calculates the feature amount using a reduced image after image quality adjustment and enlargement processing. In order to obtain a feature amount, the feature amount calculating section 327 calculates, for example, the dispersion using a reduced image, on which image quality enhancement and enlargement processing are made by the enlarging processing section 41 described below. That is the calculation is made by using a low frequency image after image quality enhancement. The feature amount calculating section 327 outputs the calculated feature amount to the coring processing section 328.

The coring processing section 328 is a difference image processing section processing a difference image. The coring processing section 328 sets a threshold value based on the noise amount estimated by the noise amount estimating section 321 and the feature amount calculated by the feature amount calculating section 327. Further, the coring processing section 328 adjusts the signal level of the difference image for each pixel in accordance with the set threshold value and the coring characteristics, and outputs the same to the synthesizing processing unit 40.

The enlarging processing section 41 of the synthesizing processing unit 40 enlarges the reduced image after image quality enhancement, which is supplied from the reduced image processing section 31, to restore the size of the input image to the same image size as the difference image. The synthesizing processing unit 40 outputs the enlarged image to the addition processing section 42 and the feature amount calculating section 327 of the difference image handling unit 32d.

The addition processing section 42 adds the enlarged image after image quality enhancement, which is supplied from the enlarging processing section 41, to the difference image with adjusted gain, which is supplied from the difference image handling unit 32d, to generate an output image.

### Configuration and Operation of Each Section

Subsequently, a configuration and an operation of each section will be described. The reducing processing section 21 has the same configuration shown in FIG. 4; and performs the operation shown in FIG. 5 to generate a reduced image. The enlarging processing section 22 has the same configuration shown in FIG. 7; and performs the operation shown in FIG. 8 to generate an enlarged image. The difference calculating section 23 has the same configuration shown in FIG. 10, which subtracts the reduced image enlarged by the enlarging processing section 22 from the input image to generate a difference image representing high-frequency component of the input image.

The reduced image processing section 31 removes noises from the reduced image and enhances the edge thereof to enhance the image quality of the reduced image as described above.

The noise amount estimating section 321 of the difference image handling unit 32d estimates the noise amount of the input image by calculating the Formula (1) or using the table. In order to obtain the feature amount, the feature amount calculating section 327 calculates, for example, the dispersion for each pixel by using adjacent pixels based on the reduced image after image quality enhancement and enlargement processing.

The coring processing section 328 sets a threshold value in accordance with the noise amount and the feature amount for each pixel. For example, when a large noise amount is estimated, the threshold value is increased so as to more reliably suppress the noises. When a feature amount is large, that is, when the dispersion gets larger in the low frequency image after image quality enhancement and enlargement processing, for example, since the pixel as the calculation target of the feature amount is the pixel representing a profile, a large value set for the threshold value suppresses the signal level of the high-frequency component in the profile portion. Therefore, a smaller value is set for the threshold value to prevent the sharpness of the profile or the like from being decreased. The coring processing section 328 determines signals smaller than the threshold value as noises based on the set threshold value and the coring characteristics, and adjusts the signal level of the difference image. The signal level of the difference image is output to the synthesizing processing unit 40.

The enlarging processing section 41 of the synthesizing processing unit 40 is configured same as the enlarging processing section 22, and performs the same operation as that of the enlarging processing section 22 to enlarge the reduced image after image quality enhancement to the image size of the difference image. That is, a low frequency image with enhanced image quality is generated, and is output to the addition processing section 42 and the feature amount calculating section 327.

The addition processing section 42 adds the image supplied from the enlarging processing section 41 to the difference image supplied from the coring processing section 328 of the difference image handling unit 32d for each pixel, to generate an output image in which noises of the high-frequency component are removed and image quality of the low-frequency component is enhanced; and outputs the same.

As described above, according to the fourth embodiment, same as the third embodiment, the image quality can be easily enhanced with a simple configuration at a low processing cost. Also, the image quality can be enhanced for each frequency band. Moreover, high-frequency components with small signal level are suppressed as noises and an output image with satisfactory image quality is generated. Further, in the fourth embodiment, since the threshold value is adjusted based on the feature amount which is calculated by using a low-frequency component image, the coring processing can be made on the difference image while preventing sharpness of the profile or the like from being decreased.

### 6. Fifth Embodiment

In the above-described first-fourth embodiments, the description has been made on the cases in which the input image is processed being separated into two hierarchies; i.e. a difference image as a high frequency image and a reduced image as a low frequency image. Here, when the frequency separation unit, the image processing unit and the synthesizing processing unit are hierarchically arranged, the input image can be separated into frequency bands in three or more hierarchies, and the image can be adjusted for each frequency band. That is, the frequency separation unit reduces an input image; restores the reduced image to an image size before reduction to calculate a difference from the input image before reduction; then, separates the input image into a reduced image and a difference image; and repeats the separation using the reduced image as the input image. Thus, a reduced image and a plurality of difference images are generated. The image processing unit performs image processing on at least either one of the reduced image and the plurality of difference images. The synthesizing processing unit synthesizes the reduced image and the plurality of difference images, at least either one of which is image-processed, at the same image size.

In the fifth embodiment, description will be made on the case in which the input image is processed being separated into, for example, three frequency bands. In the following description, an image of high frequency band is referred to as high frequency image; an image of low frequency band is referred to as low frequency image; and an image of intermediate frequency band is referred to as intermediate frequency image.

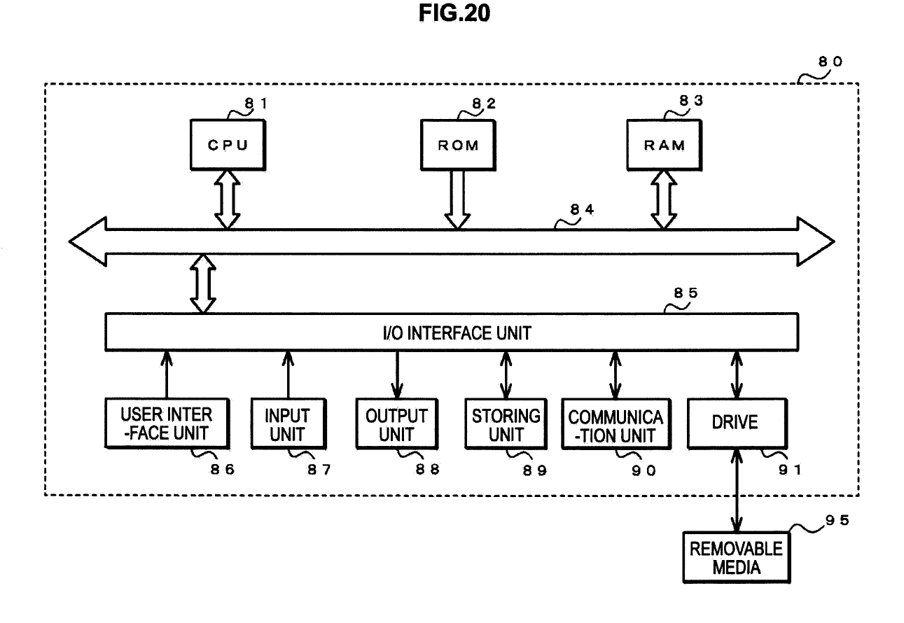

FIG. 19 illustrates a configuration of the fifth embodiment. An image processing apparatus 10e is provided with frequency separation units 20-1 and 20-2, an image processing unit 30e, and synthesizing processing units 40-1 and 40-2. The frequency separation units 20-1 and 20-2 are hierarchically arranged. That is, a reduced image generated by the frequency separation unit 20-1 is provided as the input image to the frequency separation unit 20-2. The image processing unit 30e includes a reduced image processing section 31 and difference image handling units 32-1 and 32-2.

The reducing processing section 21 of the frequency separation unit 20-1 reduces the size of the input image. The reducing processing section 21 reduces the size of the input image to generate a reduced image in which high-frequency component of the input image is eliminated in accordance with a reduction ratio. The reducing processing section 21 outputs the generated reduced image to the enlarging processing section 22 and the difference image handling unit 32-1 of the image processing unit 30e.

The enlarging processing section 22 enlarges the reduced image to restore the reduced image to the size of the input image, and outputs the enlarged image to the difference calculating section 23.

The difference calculating section 23 calculates a difference between the input image and the reduced image which is enlarged to the image size before reduction and generates the difference image. Here, even when the reduced image is enlarged to the image size before reduction, since the high-frequency component of the input image is being eliminated, the difference image results in a high frequency image which represents high-frequency component of the input image. The difference calculating section 23 outputs the difference image representing the high-frequency component of the input image to the image processing unit 30.

The reducing processing section 21 of the frequency separation unit 20-2 performs reduction processing on the reduced image generated by the frequency separation unit 20-1 as the input image. The reducing processing section 21 reduces the input image to generate reduced image, in which high-frequency component of the input image is eliminated in accordance with the reduction ratio. The reducing processing section 21 outputs the generated reduced image to the enlarging processing section 22 and the reduced image processing section 31 of the image processing unit 30e.

The enlarging processing section 22 enlarges the reduced image to restore the same to an input image size, and outputs the enlarged image to the difference calculating section 23.

The difference calculating section 23 calculates a difference between the input image and the reduced image which is enlarged to the image size before reduction to generate a difference image. Here, even when the reduced image is enlarged to the image size before reduction, since the high-frequency component of the input image is being eliminated, the difference image is an intermediate frequency image which represents high-frequency component of the reduced image which is generated by the frequency separation unit 20-1; that is, an intermediate component of the input image. The difference calculating section 23 outputs the difference image representing the intermediate component of the input image to the difference image handling unit 32-2 of the image processing unit 30e.

The reduced image processing section 31 of the image processing unit 30e enhances the image quality of the reduced image. The reduced image processing section 31 performs noise removal processing and sharpness adjustment on the reduced image to enhance the image quality of the reduced image, and outputs the same to the synthesizing processing unit 40-2.

The difference image handling unit 32-1 of the image processing unit 30e performs the same processing as the above-described difference image handling unit 32a (32b, 32c and 32d), and outputs the difference image after level adjustment to the synthesizing processing unit 40-1. Likewise, the difference image handling unit 32-2 performs the same processing as the above-described difference image handling unit 32a (32b, 32c and 32d), and outputs the difference image after level adjustment to the synthesizing processing unit 40-2.

The enlarging processing section 41 of the synthesizing processing unit 40-2 enlarges the reduced image with enhanced image quality, which is supplied from the reduced image processing section 31, to restore the size of the input image to the same image size as the difference image generated by the difference calculating section 23 of the frequency separation unit 20-2, and outputs the enlarged image to the addition processing section 42.

The addition processing section 42 adds the enlarged image after image quality enhancement, which is supplied from the enlarging processing section 41, to the difference image with adjusted gain, which is supplied from the difference image handling unit 32-2, to output the synthetic image to the synthesizing processing unit 40-1.

The enlarging processing section 41 of the synthesizing processing unit 40-1 performs enlargement processing to enlarge the synthetic image which is supplied from the synthesizing processing unit 40-2 to restore to the same image size as the difference image which is generated by the difference calculating section 23 of the frequency separation unit 20-1; i.e. to the input image size. The synthesizing processing unit 40-1 outputs the synthetic image after the enlargement processing to the addition processing section 42.

The addition processing section 42 adds the enlarged synthetic image supplied from the enlarging processing section 41 to the difference image after gain adjustment supplied from the difference image handling unit 32-1 to generate an output image.

In the fifth embodiment, the configuration, in which a plurality of synthesizing processing units are provided to synthesize images in order, has been described. However, such configuration, in which, for example, the images are synthesized to the input image size after aligning the image size of the images output from the image processing unit 30e, may be employed.

As described above, according to the fifth embodiment, since the frequency separation unit and the synthesizing processing unit are hierarchically arranged, images can be generated from the input image for each of the plurality of frequency components. Therefore, by adding the images after adjusting the signal level and the image quality to align the image size with each other for each frequency component, the image quality can be enhanced with a simple configuration for each frequency component.

### 7. Implementation of Processing with Program

A sequence of processing described above may be implemented with hardware or software. When the sequence of processing implemented with software, a computer, in which a program constituting the software is installed in dedicated hardware, is used. Or, when a general-purpose personal computer or the like is used, which is capable of executing various functions by various programs installed; for example, a program is installed from a recording medium.

FIG. 20 is a diagram illustrating an example of a configuration of hardware of a computer which executes the sequence of processing of program as described above.

In a computer 80, a central processing unit (CPU) 81, a read only memory (ROM) 82 and a random access memory (RAM) 83 are connected to each other via a bus 84. The bus 84 is further connected to an I/O interface unit 85. The I/O interface unit 85 is connected to a user interface unit 86 such as a keyboard and a mouse; an input unit 87 for inputting image data; an output unit 88 like a display; and a storing unit 89 like a hard disk, a non-volatile memory and the like. Moreover, the I/O interface unit 85 is connected to a communication unit 90 such as a network interface, and a drive 91 for driving a removable media 95 such as a magnetic disk, an optical disk, a magnet-optical disk or a semiconductor memory.

In a computer which is configured as described above, the CPU 81 executes the above-described sequence of processing by loading a program stored in, for example, the storing unit 89 on the RAM 83 via the I/O interface unit 85 and the bus 84.

A program executed by the computer (CPU 81) is provided being stored in, for example, a magnetic disk (including flexible disk), an optical disk, a compact disk-read only memory (CD-ROM), a digital versatile disk (DVD), a magnet-optical disk, or a removable media 95 which is a package media of semiconductor memory or the like. Or the program may be provided via wired or wireless transmission medium such as local area network, Internet, digital satellite broadcast and the like.

The program is installed in the storing unit 89 via the I/O interface unit 85 by mounting the removable media 95, which is a recording medium storing the program, on the drive 91. Or, the program may be installed in the storing unit 89 by receiving with the communication unit 90 via a wired or wireless transmission medium. Or, the program may be previously installed in the ROM 82 and/or the storing unit 89.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An image processing apparatus including:

a frequency separation unit that reduces an input image, restores the reduced input image to an image size before reduction, calculates a difference from the input image before reduction, and separates the input image into a reduced image and a difference image;

an image processing unit that processes at least either one of the reduced image or the difference image; and

a synthesizing processing unit that synthesizes the reduced image and the difference image, at least either one of which is image-processed, at a same image size.

(2) The image processing apparatus according to (1),

wherein the image processing unit includes a noise amount estimating section that determines a noise amount for each pixel based on the input image, and a difference image processing unit that processes the difference image based on the estimated noise amount.

(3) The image processing apparatus according to (2),

wherein the image processing unit includes a feature amount calculating section that calculates a feature amount representing non-flatness for each pixel based on the difference image, and

wherein the difference image processing unit processes the image based on the noise amount and the feature amount.

(4) The image processing apparatus according to (3),

wherein the difference image processing unit sets a gain coefficient based on the noise amount and the feature amount, and adjusts the gain based on the gain coefficient.

(5) The image processing apparatus according to (4),

wherein the image processing unit includes a gain coefficient storing section that stores the set gain coefficient, and

wherein the difference image processing unit sets the gain coefficient using a gain coefficient at a same pixel position stored in the gain coefficient storing section.

(6) The image processing apparatus according to any one of (2) to (5),

wherein the difference image processing unit performs coring processing to suppress a signal having a value smaller than or equal to a threshold value and sets the threshold value based on the noise amount.

(7) The image processing apparatus according to (6),

wherein the image processing unit includes a feature amount calculating section that calculates a feature amount representing non-flatness based on the reduced image after image processing, and

wherein the difference image processing unit sets the threshold value based on the noise amount and the feature amount representing non-flatness of the reduced image.

(8) The image processing apparatus according to any one of (1) to (7),

wherein the image processing unit includes a reduced image processing section that processes the reduced image, and

wherein the reduced image processing section performs image quality enhancement processing as the image processing.

(9) The image processing apparatus according to (8),

wherein the reduced image processing section performs at least either one of noise removal or sharpness enhancement processing as the image quality enhancement processing.

In the image processing apparatus, the image processing method, the program and the recording medium according to an embodiment of the present technology, an input image is reduced and the reduced image is restored to an image size before reduction to calculate a difference from the input image before reduction, and the input image is separated into a reduced image and a difference image each having a different frequency band. Also, at least either one of the reduced image and the difference image is image-processed; and at least either one of image-processed the reduced image and the difference image are synthesized at the same image size. Accordingly, the image quality is enhanced with a simple configuration at a low processing cost without providing a large scale memory or buffer. Also, since the image quality can be enhanced at each frequency band, for example, the image processing apparatus, the image processing method, the program and the recording medium according to an embodiment of the present technology are applicable to imaging apparatuses, image recording apparatuses, image editing apparatuses and the like.

The present disclosure contains subject matter related to that disclosed in Japanese Priority Patent Application JP 2011-150706 filed in the Japan Patent Office on Jul. 7, 2011, the entire content of which is hereby incorporated by reference.

What is claimed is:

1. An image processing apparatus comprising:
a frequency separation unit that reduces an input image, restores the reduced input image to an image size before reduction, calculates a difference from the input image before reduction, and separates the input image into a reduced image and a difference image;
an image processing unit that processes at least either one of the reduced image or the difference image; and
a synthesizing processing unit that synthesizes the reduced image and the difference image, at least either one of which is image-processed, at a same image size.

2. The image processing apparatus according to claim 1,
wherein the image processing unit includes a noise amount estimating section that determines a noise amount for each pixel based on the input image, and a difference image processing unit that processes the difference image based on the estimated noise amount.

3. The image processing apparatus according to claim 2,
wherein the image processing unit includes a feature amount calculating section that calculates a feature amount representing non-flatness for each pixel based on the difference image, and
wherein the difference image processing unit processes the image based on the noise amount and the feature amount.

4. The image processing apparatus according to claim 3,
wherein the difference image processing unit sets a gain coefficient based on the noise amount and the feature amount, and adjusts the gain based on the gain coefficient.

5. The image processing apparatus according to claim 4,
wherein the image processing unit includes a gain coefficient storing section that stores the set gain coefficient, and
wherein the difference image processing unit sets the gain coefficient using a gain coefficient at a same pixel position stored in the gain coefficient storing section.

6. The image processing apparatus according to claim 2,
wherein the difference image processing unit performs coring processing to suppress a signal having a value smaller than or equal to a threshold value and sets the threshold value based on the noise amount.

7. The image processing apparatus according to claim 6,
wherein the image processing unit includes a feature amount calculating section that calculates a feature amount representing non-flatness based on the reduced image after image processing, and
wherein the difference image processing unit sets the threshold value based on the noise amount and the feature amount representing non-flatness of the reduced image.

8. The image processing apparatus according to claim 1,
wherein the image processing unit includes a reduced image processing section that processes the reduced image, and
wherein the reduced image processing section performs image quality enhancement processing as the image processing.

9. The image processing apparatus according to claim 8,
wherein the reduced image processing section performs at least either one of noise removal or sharpness enhancement processing as the image quality enhancement processing.

10. An image processing method comprising
reducing an input image, restoring the reduced input image to an image size before reduction, calculating a difference from the input image before reduction, and separating the input image into a reduced image and a difference image;
processing at least either one of the reduced image or the difference image; and
synthesizing the reduced image and the difference image, at least either one of which is image-processed, at a same image size.

11. A program for causing a computer to execute image processing, comprising:
a sequence of reducing an input image, restoring the reduced input image to an image size before reduction, calculating a difference from the input image before reduction, and separating the input image into a reduced image and a difference image;
a sequence of processing at least either one of the reduced image or the difference image; and
a sequence of synthesizing the reduced image and the difference image, at least either one of which is image-processed, at a same image size.

12. A computer-readable recording medium storing a program for causing a computer to execute image processing, comprising:
a sequence of reducing an input image, restoring the reduced input image to an image size before reduction, calculating a difference from the input image before reduction, and separating the input image into a reduced image and a difference image;
a sequence of processing at least either one of the reduced image or the difference image; and
a sequence of synthesizing the reduced image and the difference image, at least either one of which is image-processed, at a same image size.

13. An image processing apparatus comprising
a frequency separation unit that reduces an input image, restores the reduced input image to an image size before reduction, calculates a difference from the input image before reduction, separates the input image into a reduced image and a difference image, repeats the separation using the reduced image as the input image, and thereby generating a reduced image and a plurality of difference images;
an image processing unit that processes at least either one of the reduced image or the plurality of difference images; and
a synthesizing processing unit that synthesizes the reduced image and the plurality of difference images, at least either one of which is image-processed, at a same image size.

14. An image processing method comprising:
reducing an input image, restoring the reduced input image to an image size before reduction, calculating a difference from the input image before reduction, separating the input image into a reduced image and a difference image, repeating the separation using the reduced image as the input image, and thereby generating a reduced image and a plurality of difference images;
processing at least either one of the reduced image or the plurality of difference images; and
synthesizing the reduced image and the plurality of difference images, at least either one of which is image-processed, at a same image size.

15. A program for causing a computer to execute image processing, comprising:
a sequence of reducing an input image, restoring the reduced input image to an image size before reduction, calculating a difference from the input image before reduction, separating the input image into a reduced image and a difference image, repeating the separation using the reduced image as the input image, and thereby generating a reduced image and a plurality of difference images;
a sequence of processing at least either one of the reduced image or the plurality of difference images; and
a sequence of synthesizing the reduced image and the plurality of difference images, at least either one of which is image-processed, at a same image size.

16. A computer-readable recording medium storing a program for causing a computer to execute image processing, comprising:
a sequence of reducing an input image, restoring the reduced input image to an image size before reduction, calculating a difference from the input image before reduction, separating the input image into a reduced image and a difference image, repeating the separation using the reduced image as the input image, and thereby generating a reduced image and a plurality of difference images;
a sequence of processing at least either one of the reduced image or the plurality of difference images; and
a sequence of synthesizing the reduced image and the plurality of difference images, at least either one of which is image-processed, at a same image size.
